(19) United States
(12) Patent Application Publication
(10) Pub. No.: US 2003/0070029 A1
(43) Pub. Date: Apr. 10, 2003

(54) Data transmission transceiver unit and program updating method therefor

(75) Inventors: Koichi Kamata, Fukushima-ken (JP); Katsutoshi Obara, Fukushima-ken (JP)

Correspondence Address: Brinks Hofer Gilson & Lione, P. O. Box 10395, Chicago, IL, 60610, US

(73) Assignee: Alps Electric Co., Ltd.

(21) Appl. No.: 10/256,515

(22) Filed: Sep. 27, 2002

(30) Foreign Application Priority Data
Oct. 4, 2001 (JP) 2001-308526

(51) Int. Cl. G06F 13/14

(52) U.S. Cl. 710/305

(57) ABSTRACT

A data transmission transceiver unit includes a flash ROM for storing a communication processing program, a CPU for controlling the entire signal processing in accordance with the communication processing program, a static RAM for temporarily storing the communication processing program, a signal processor for performing signal processing under the control of the CPU, a transceiver circuit, and a port for connecting the CPU to an external computer. The flash ROM stores an updating control program for controlling the CPU when updating the communication processing program.

### BACKGROUND OF THE INVENTION

1. Field of the Invention

The present invention relates to data transmission transceiver units for connecting to computers and performing communication processing and to program updating methods therefor.

2. Description of the Related Art

FIG. 3 shows the configuration of a known data transmission transceiver unit (hereinafter referred to as a unit) 21. The unit 21 includes a CPU (Central Processing Unit) 22 for controlling the entire unit 21, a flash ROM (Read Only Memory) 23 for storing a communication processing program for the control of the CPU 22, a static RAM (Random Access Memory) 24 for temporarily storing the communication processing program stored in the flash ROM 23, a serial port 25 for connecting to an external computer (not shown), a serial interface 26 provided between the serial port 25 and the CPU 22, a signal processor 27 for performing modem processing of transmission data and reception data under the control of the CPU 22, and a transceiver circuit 28 for transmitting data to and receiving data from another data transmission transceiver unit.

In the above arrangement, the communication processing program stored in the flash ROM 23 includes a program for performing modem processing performed by the signal processor 27 and processing a command from the external computer and data required for performing the processing. The program and data are stored by a dedicated ROM writer (not shown) and incorporated in the unit 21.

The CPU 22 controls the signal processor 27 in accordance with the communication processing program stored in the flash ROM 23, outputs the result to the external computer, and controls the signal processor 27 using data input from the computer.

With the foregoing known arrangement, the signal processor 27 performs processing in accordance with the communication processing program stored in the flash ROM 23. When upgrading the version of the communication processing program, such as when adding a processing function or increasing the processing speed, the contents of the program need to be updated. In such a case, it is necessary to remove the flash ROM 23 incorporated in the unit 21, delete the previously stored communication processing program, and write a new communication processing program that will replace the previous program using the dedicated ROM writer. The procedure of updating the program is complicated.

### SUMMARY OF THE INVENTION

Accordingly, it is an object of the present invention to update a stored communication processing program without removing a flash ROM from a unit.

In order to achieve the foregoing objects, according to an aspect of the present invention, a data transmission transceiver unit is provided including a flash ROM for storing a communication processing program; a CPU for controlling the entire signal processing in accordance with the communication processing program; a static RAM for temporarily storing the communication processing program; a signal processor for performing signal processing under the control of the CPU; a transceiver circuit; and a port for connecting the CPU to an external computer. The flash ROM stores an updating control program for controlling the CPU when updating the communication processing program. Accordingly, the previous communication processing program can be updated to the new communication processing program using the external computer without removing the flash ROM incorporated in the unit.

According to another aspect of the present invention, a program updating method is provided including a first step of writing a communication processing program and an updating control program for controlling a CPU when updating the communication processing program to a flash ROM using a ROM writer; a second step of calling the updating control program from an externally connected computer; a third step of transmitting a write program, which runs on a static RAM, for updating the communication processing program from the computer to the static RAM; a fourth step of deleting the communication processing program in accordance with the write program transmitted to the static RAM; a fifth step of requesting a new communication processing program replacing the old program from the computer; and a sixth step of writing the new communication processing program transmitted from the computer to the flash ROM. Accordingly, the unit can automatically update the program by itself.

### BRIEF DESCRIPTION OF THE DRAWINGS

FIG. 1 is a diagram showing the configuration of a data transceiver unit according to the present invention;

FIG. 2 is a flowchart of a process of updating a program in the data transceiver unit according to the present invention; and

FIG. 3 is a diagram showing the configuration of a known data transceiver unit.

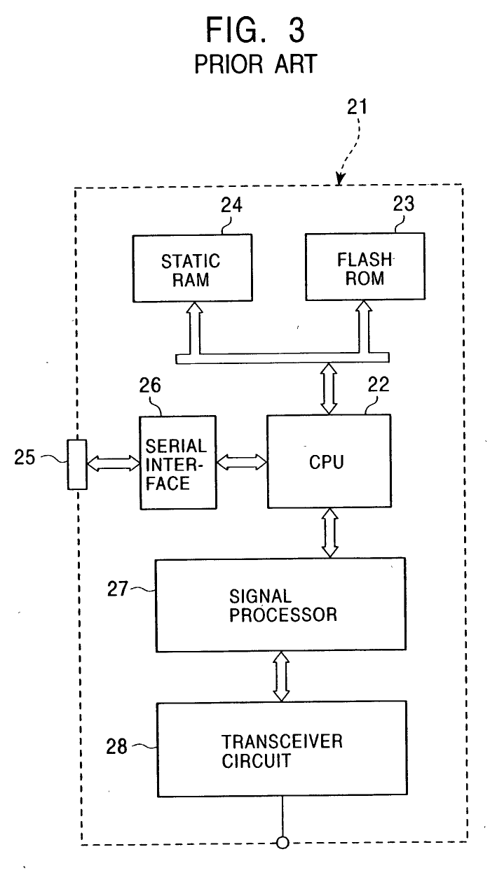

### DESCRIPTION OF THE PREFERRED EMBODIMENTS

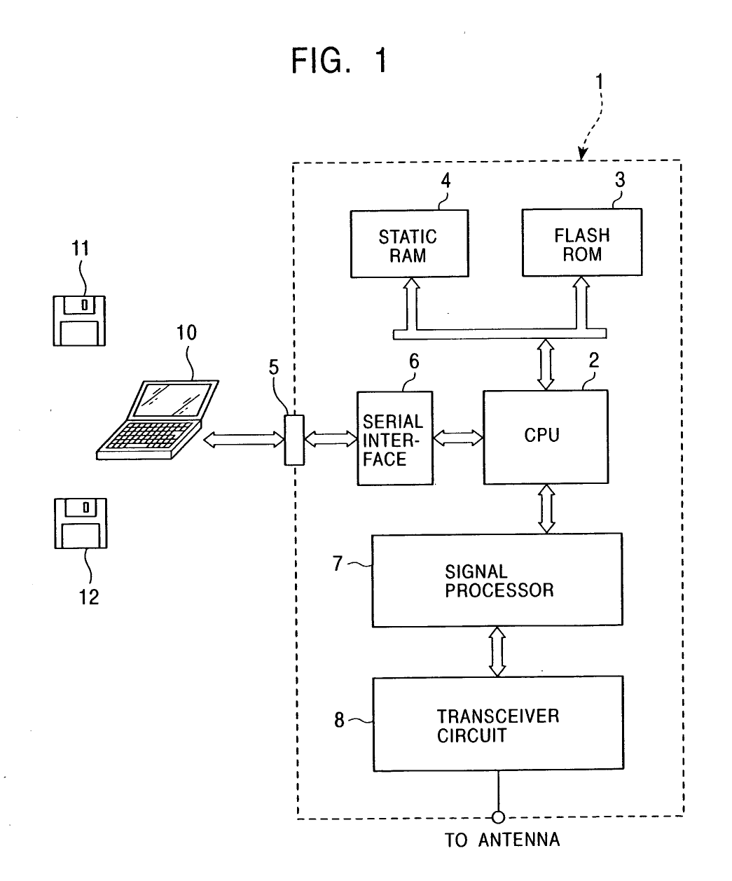

FIG. 1 shows a data transceiver unit (hereinafter referred to as a unit) 1 according to the present invention. The unit 1 includes a CPU 2 for controlling the entire unit 1, a flash ROM 3 for storing a communication processing program for the control of the CPU 2, a static RAM 4 for temporarily storing the communication processing program stored in the flash ROM 3, a serial port 5 for connecting the unit 1 to an external computer 10, a serial interface 6 provided between the serial port 5 and the CPU 2, a signal processor 7 for performing modem processing of transmission data and reception data under the control of the CPU 2, and a transceiver circuit 8 for transmitting data to and receiving data from another data transmission transceiver unit.

In the above arrangement, the communication processing program stored in the flash ROM 3 includes a program for performing modem processing by the signal processor 7 and for processing a command from the external computer 10 and data required for performing the processing. The program and data is stored using a dedicated ROM writer (not shown) and incorporated in the unit 1.

Generally, the CPU 2 controls the signal processor 7 in accordance with the communication processing program stored in the flash ROM 3, outputs the result to the external computer 10, and controls the signal processor 7 using data input from the computer 10.

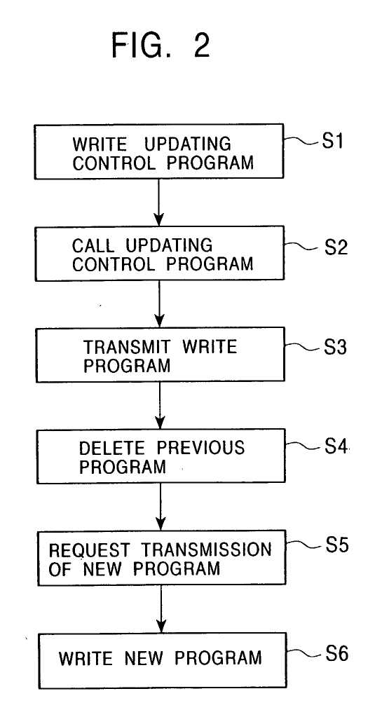

Sometimes the communication processing program stored in the flash ROM 3 is updated for upgrading the version of the program. In this case, the external computer 10 and two programs to be transmitted through the computer 10 to the unit 1 are provided. One program is a new communication processing program 11 replacing the old communication processing program, and the other program is a flash ROM write program 12 for writing the new communication processing program 11. The flash ROM write program 12 runs on the static RAM 4 in the unit 1. Referring to FIG. 2, a communication processing program updating method will now be described.

In order to update the communication processing program 11, besides the communication processing program stored in the flash ROM 3, an updating control program for controlling the CPU 2 when updating the communication processing program is stored in the flash ROM 3 (step S1). The updating control program is not used in the normal operating state of the unit 1. At the same time as the communication processing program is written, the updating control program is written by the ROM writer. After the updating control program has been written, the programs on the flash ROM 3 are read into the unit 1.

In step S2, the externally connected computer 10 calls the updating control program from the flash ROM 3 and causes the CPU 2 to enter a state in which the program can be updated. In step S3, the write program 12 is transmitted from the computer 10 to the static RAM 4. In step S4, the previous communication processing program is deleted in accordance with the write program 12 transmitted to the static RAM 4.

When the previous communication processing program is deleted, in step S5, the CPU 2 requests the computer 10 to transmit the new communication processing program 11 replacing the previous program. In step S6, the new communication processing program 11 is transmitted from the computer 10 to the unit 1 and written by the CPU 2 to the flash ROM 3.

What is claimed is:

1. A data transmission transceiver unit comprising:
a flash ROM for storing a communication processing program;
a CPU for controlling the entire signal processing in accordance with the communication processing program;
a static RAM for temporarily storing the communication processing program;
a signal processor for performing signal processing under the control of the CPU;
a transceiver circuit; and
a port for connecting the CPU to an external computer,
wherein the flash ROM stores an updating control program for controlling the CPU when updating the communication processing program.

2. A program updating method comprising:
a first step of writing a communication processing program and an updating control program for controlling a CPU when updating the communication processing program to a flash ROM using a ROM writer;
a second step of calling the updating control program from an externally connected computer;
a third step of transmitting a write program, which runs on a static RAM, for updating the communication processing program from the computer to the static RAM;
a fourth step of deleting the communication processing program in accordance with the write program transmitted to the static RAM;
a fifth step of requesting a new communication processing program replacing the old program from the computer; and
a sixth step of writing the new communication processing program transmitted from the computer to the flash ROM.
